(19) United States
(12) Patent Application Publication
(10) Pub. No.: US 2014/0122867 A1
(43) Pub. Date: May 1, 2014

(54) ENCRYPTION AND DECRYPTION OF USER DATA ACROSS TIERED SELF-ENCRYPTING STORAGE DEVICES

(71) Applicant: HCL Technologies Limited, Chennai (IN)

(72) Inventors: Subha Shrinivasan, Bangalore (IN); Simy Chacko, Hyderabad (IN)

(73) Assignee: HCL Technologies Limited, Chennai (IN)

(21) Appl. No.: 14/061,751

(22) Filed: Oct. 23, 2013

(30) Foreign Application Priority Data
Oct. 26, 2012 (IN) 4479/CHE/2012

(51) Int. Cl. G06F 21/62; H04L 29/06

(52) U.S. Cl. CPC G06F 21/6218; H04L 63/08
USPC 713/155; 713/150

(57) ABSTRACT

A method and system for automated encryption and decryption of user data across tiered self-encrypting storage devices is disclosed. A storage tier is created using self-encrypting devices. When a user logs on to an enterprise, the enterprise gateway authenticates the user with login credentials. A protocol packet is sent over the IP network to the storage tiering software. The protocol packet contains the user credentials, the storage devices that are mapped into user account. The storage tiering software identifies the list of mapped drives and maps them into devices and blocks. Further, the storage tiering software cascades all devices that contain user data. Selective decryption of the user data is then performed and is stored in a cache of each device and this data will be ready for user to use. The decrypted data from the cache will be erased when user logs off the enterprise.

### PRIORITY DETAILS

The present application is based on, and claims priority from, Indian Application Number 4479/CHE/2012, filed on 26 Oct. 2012, the disclosure of which is hereby incorporated by reference

### TECHNICAL FIELD

The embodiments herein relate to data encryption and decryption and more particularly, to automated encryption and decryption of data across tiered self-encrypting storage devices.

### BACKGROUND

Data may be stored on a storage device associated with an electronic device. In some circumstances, a user may want to secure the data so that future users may not gain access to sensitive information. For example, an employer may wish to erase data from an employee's computer so that the employee no longer has access to it. As another example, a user may erase data on an electronic device before selling it.

Sensitive data may be stored on a self-encrypting storage device, such as a self-encrypting hard disk drive. A self-encrypting storage device includes processing capabilities for encrypting data stored on the self-encrypting storage device. In some implementations, the self-encrypting storage device may also store a decryption key associated with encrypted data stored on the self-encrypting storage device. A host computer executing a software program to encrypt data and store it on storage devices. A self-encrypting storage device provides multiple procedures for securing data stored on the self-encrypting storage device. For example, a self-encrypting storage device may receive an instruction indicating a procedure to be used to secure data. The methods for securing data may include replacing data, such as with 1's or 0's, or deleting a decryption key associated with encrypted data stored on the self-encrypting storage device. In some cases, an end user may select one of the available procedures for securing data. Further, an electronic device in communication with a self-encrypting storage device selects a method for securing data on the self-encrypting storage device based on factors such as the amount of data stored on the self-encrypting storage device.

The storage industry is witnessing the wide spread use of self-encrypting storage devices from secure network attached storage (NAS) appliances to hard disk drives (HDDs) or solid state solid state drives (SSDs), which saves time and improves performance. In environments, where user data is stored across different tiers of storage devices, especially outside an enterprise firewall, encryption and decryption of the data is a key requirement to keep the data secure.

In an existing system, where user data is stored in tiered storage environments, spanning a range of different storage devices each with self-encrypting and decrypting capabilities. Each self-encrypting device will be encrypting and decrypting data, when user information is accessed. This may take some time when user is accessing the data for the first time, resulting in a decrease in performance and data retrieval specifically in scenarios of data access across the network like Tier-2 storage in cloud or a remote data center. Further, very high processing power is required in the self-encrypting devices to reduce the latencies maximum. The existing system lacks the combination of automated encryption and decryption as part of the storage services on self-encrypting and decrypting devices in a coordinated manner.

In light of above discussion, there is a need for a method and system that provides coordination among self-encrypting and decrypting storage devices in a storage tier. Further, there is a need for a method that supports automated encryption and decryption as a part of storage services on self-encrypting and decrypting devices.

### SUMMARY

Accordingly the embodiment provides a method for automated encryption and decryption of user data across an enterprise, wherein the method comprises creating storage tier with at least one self-encrypting device to store the user data, sending a protocol packet containing credentials of the user after authenticating the user by an enterprise gateway and decrypting the user data by the at least one self-encrypting device, after receiving the protocol packet.

Accordingly the embodiment provides a system for automated encryption and decryption of user data across an enterprise, wherein the system comprises an enterprise gateway, at least one self-encrypting device in a storage tier, a storage tiering software, wherein the system is configured to create a storage tier with at least one self-encrypting device to store the user data, send a protocol packet containing credentials of the user after authenticating the user by the enterprise gateway and decrypt the user data by the at least one self-encrypting device, after receiving the protocol packet by the storage tiering software in the storage tier.

Accordingly the embodiment provides a self-encrypting device for automated encryption and decryption of user data across an enterprise, wherein the self-encrypting device comprises an integrated circuit further comprising at least one processor, at least one memory having a computer program code within the circuit, the at least one memory and the computer program code configured to, with the at least one processor cause the self-encrypting device to decrypt the user data stored in data blocks of the self-encrypting device, store the decrypted user data in a volatile memory, erase the decrypted user data and encrypt the user data stored in the data blocks.

### BRIEF DESCRIPTION OF THE FIGURES

The embodiments herein will be better understood from the following detailed description with reference to the drawings, in which:

FIG. 1 illustrates a block diagram of automated encryption and decryption of user data across tiered self-encrypting storage devices, according to the embodiments disclosed herein; and

FIG. 2 illustrates a flow diagram explaining various steps involved in automated encryption and decryption of user data across tiered self-encrypting storage devices, according to the embodiments disclosed herein.

### DETAILED DESCRIPTION OF EMBODIMENT

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein disclose a method and system for automated encryption and decryption of user data across tiered self-encrypting storage devices. Initially, all the user data that is stored in self-encrypting devices (SEDs) such as hard disks, drives and so on of an enterprise are integrated to form a storage tier. The storage tier with all these devices is monitored by storage tiering software. When a user logs on to an enterprise for accessing the data, the gateway of the enterprise authenticates the user by using the login credentials of the user. Further, the gateway of the enterprise sends a protocol packet to the storage tiering software that controls the storage tier. The protocol packet contains the user credentials, information about the storage devices that are mapped into user account. The storage tiering software identifies the list of mapped drives and maps them into devices and data blocks of SEDs. Further, the storage tiering software cascades all devices that contain user data. Selective decryption of the user data is then performed and is stored in a cache of each device and this data will be ready for user to use. The decrypted data from the cache will be erased when the user logs off the enterprise. Further, all the mapped drives are remapped into specific blocks on the devices and the information is saved and encrypted by the SEDs.

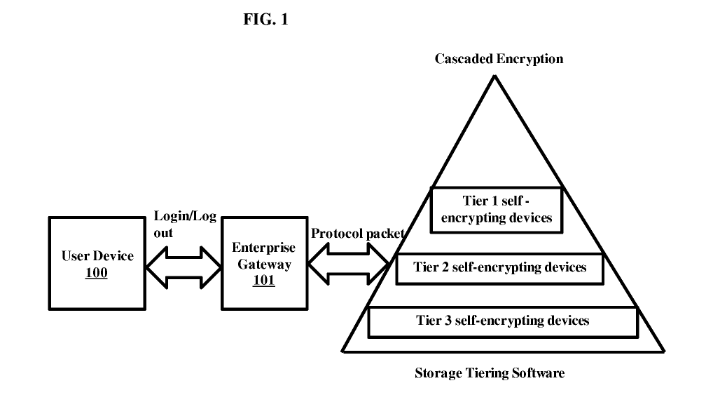

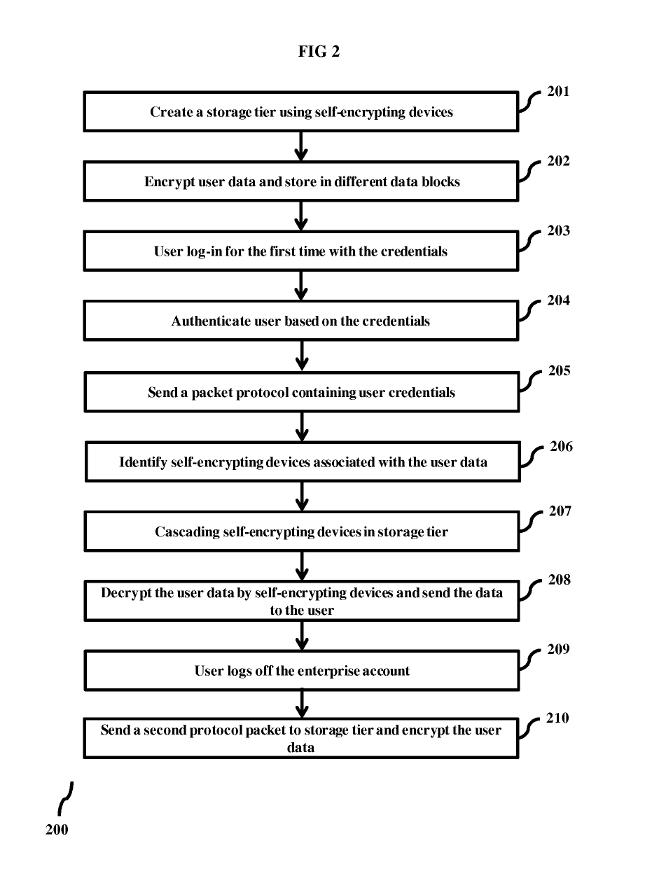

Referring now to the drawings, and more particularly to FIGS. 1 and 2, where similar reference characters denote corresponding features consistently throughout the figures, there are shown embodiments.

FIG. 1 illustrates a block diagram of automated encryption and decryption of user data across tiered self-encrypting storage devices, according to the embodiments disclosed herein. As depicted in the figure, a user device 100 is connected to an enterprise gateway 101 and the enterprise gateway 101 is associated with a storage tier. The storage tier comprises a plurality of self-encrypting devices (SEDs). The storage tier can be created with Tier-1 comprising a plurality of SEDs, Tier-2 comprising a plurality of SEDs. In a similar way, there can exist multiple numbers of tiers with SEDs in a storage tier. The storage tier with a plurality of self-encrypting devices in each tier is monitored by storage tiering software.

In an embodiment, the storage tiering software can also monitor the enterprise gateway 101.

In an embodiment, the SEDs within a storage tier can be a self-encrypting solid state drive (SSD), self-encrypting hard disk drive (HDD), self-encrypting HDD over a network or cloud and the like.

It is assumed that the devices in the storage tier are capable of automatic encryption and decryption. Further, the method herein also assumes that Tier-2 storage may at some point move to cloud. Even when the storage moves to the cloud, if the storage medium is a self-encrypting device, then the device has to decrypt and encrypt the data whenever an access is performed. Hence the method disclosed herein is applicable for any Tier-2 storage over the network or cloud.

The method described herein is used predominantly in environments where user can access any information from any device and in particular where third party infrastructure such as cloud storage is involved as Tier-2 storage. In Tier-2 storage scenarios, security and retention of identity is of utmost importance. Thus a single trigger for automatically encrypting and decrypting of data without much latency is of great advantage to the end user.

Initially, a storage tier is created with all the SEDs that can store data which is related to plurality of users across the enterprise. In an embodiment, the data of all the users of the enterprise is integrated from various departments of the enterprise and stored in a storage tier. In an embodiment, storage tiering software is used in the intelligent storage of data across the storage tiers. The storage tiering software stores the user data starting form highest performing self-encrypting device to the lowest performing self-encrypting device. For example, the storage tiering software stores the data in SEDs based on the usage of the data by the user. It will store the most frequently used data by the user in a flash memory so that the data retrieval from the flash memory is fast and can provide high performance. Further, the storage tiering software monitors a plurality of SEDs within the storage tier.

The user with a user device 100, login an enterprise through a web browser using his/her credentials. This log on request from the user device 100 will be sent to the enterprise gateway 101, where the credentials of the user are validated. If the credentials provided by the user are valid, then the user is allowed to gain the access of the data that is associated with him/her across the enterprise.

In an embodiment, the device 100 can be any type of mobile telephone, a cellular phone, a personal communications system (PCS) terminal that may combine a cellular radiotelephone with data processing, facsimile, and/or data communications capabilities, an electronic notepad, a laptop, a personal computer, a tablet, a personal digital assistant (PDA) that can include a telephone, a gaming device or console, a peripheral (e.g., wireless headphone), a digital camera, a media player and the like.

In an embodiment, the enterprise gateway 100 is a server that authenticates the user identity and login credentials. Once the user is authenticated by the enterprise gateway 101, it sends a protocol packet to the storage tiering software with the user login as a trigger over an IP network. The storage tiering software of the storage tier receives the protocol packet from the enterprise gateway 101 and identifies the devices that are associated with the user data and sends the protocol packet to all the identified SEDs.

In an embodiment, the packet protocol sent by the enterprise gateway 101 comprises the user identification details, information about the storage devices that are mapped into his/her account and location about where to encrypt or decrypt. Once the storage tiering software receives this protocol packet, it identifies the list of drives mapped to the user data and maps them into devices and data blocks. This information is then used to send the protocol packet to all the devices containing the user data. Selective decryption of the user data is then performed and is stored in a cache memory of each SED. This decrypted data stored in cache memory is ready for user to use. The decrypted data will be erased from the cache, when a user completes the logout sequence. Further, all the mapped drives are remapped into specific data blocks on the devices and the information is saved and encrypted.

FIG. 2 illustrates a flow diagram explaining the various steps involved in automated encryption and decryption of user data across tiered self-encrypting storage devices, according to the embodiments disclosed herein. As depicted in the flow diagram 200, initially, an organization or an enterprise creates (201) storage tier using self-encrypting devices. There can be a plurality of self-encrypting devices SEDs within the storage tier. The storage tier supports the SEDs in plurality of tiers, for example tier with SSD, Tier-2 with HDD and so on. Further, storage tiering software is used in the intelligent storage of data across the storage tiers.

The user account is created in the enterprise for the user to access his/her data across the enterprise. With this user account, the user can access his/her data stored in self-encrypting devices of the enterprise using a user device 100.

Further, the SEDs encrypts (202) the user data and stores the data in different data blocks. The user log-in (203) the enterprise using his/her enterprise account. In an embodiment, the user logs on to the enterprise using a web browser in the user device 100. The user submits his/her credentials to log on to his enterprise account for accessing the data that is stored in the SEDs. The enterprise gateway 101 authenticates (204) the user based on the credentials submitted by the user. Once the enterprise gateway authenticates the user, it triggers a protocol packet and sends (205) the protocol, packet to the storage tiering software of the storage tier. In case, the user authentication at the enterprise gateway 101 fails, the trigger for encryption and decryption will not happen.

In an embodiment, enterprise gateway directly sends the protocol packet to the SEDs that are associated with the user data in all the tiers that are present within the storage tier. In an embodiment, for enabling all the devices in the storage tier to perform the decryption, a protocol packet is transmitted over the IP network to all the storage devices with the user credentials.

In an embodiment, the packet protocol sent by the enterprise gateway 101 comprises the user identification details, information of storage devices that are mapped into his/her account and location about where to encrypt or decrypt. The storage tiering software identifies (206) all the SEDs that are associated with the user data within the storage tier. Once the storage tiering software receives the protocol packet, it identifies the list of mapped drives of the user data and maps them into devices and data blocks. This information is then used to send the protocol packet to all the devices containing the user data.

Further, the storage tiering software cascades (207) all the SEDs that are associated with the user data in the storage tier after identification of SEDs that are associated with the user data. Once the cascading of all SEDs in the storage tier is done by the storage tiering software, the self-encrypting devices decrypt (208) the user data and maintains the decrypted data in their respective volatile memories (cache). This decrypted data is ready for the user to use. In case, the user does not access this data for a particular period of time, the decrypted data will be erased automatically from the cache and the cache will be made available for any other user who has logged onto the enterprise.

In an embodiment, there exists a predefined rule for selecting a data block to decrypt on receiving the protocol packet by the SED. This is due to the fact that the cache on the storage devices is rather small and can accommodate only a small amount of decrypted or encrypted data.

When the user logs off (209) his/her enterprise account, then the enterprise gateway 101 sends (210) a second protocol packet to all the SEDs in the storage tier. On receiving the second protocol packet from the enterprise gateway, the SEDs within the storage tier will erase the decrypted data from their respective cache to make more space available to other users. Further, all the mapped drives are remapped into specific blocks on the devices and the information is saved and encrypted. All the SEDs of the storage tier update the user data and encrypt the relevant data blocks corresponding to the user, when the user logs off the enterprise account. The various actions in the flow diagram 200 may be performed in the order presented, in a different order or simultaneously. Further, in some embodiments, some actions listed in FIG. 2 may be omitted.

The disclosed method of automated encryption and decryption of user data across tiered self-encrypting storage devices can achieve a near zero latency in data retrieval from storage devices across the networks. Further, the disclosed method leverages the storage tier and self-encrypting capabilities of storage devices. This method reduces cost by reducing the processing power requirement at the self-encrypting systems. The method disclosed can be beneficial in emerging market segments like cloud storage and bring your own device (BYOD). BYOD is a business policy of employees bringing personally owned mobile devices to their place of work and using those devices to access privileged company resources such as email, file servers and databases as well as their personal applications and data. Further, the efficiency of the method may depend on the volatile memory capacity of the self-encrypting device.

The embodiments disclosed herein can be implemented through at least one software program running on at least one hardware device and performing network management functions to control the elements. The elements shown in FIG. 1 include blocks which can be at least one of a hardware device, or a combination of hardware device and software module.

The embodiment disclosed herein specifies an automated encryption and decryption of user data across tiered self-encrypting Storage devices. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device.

The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the embodiment may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

We claim:

1. A method for automated encryption and decryption of user data across an enterprise, wherein said method comprises:
creating a storage tier with at least one self-encrypting device to store said user data;
sending a protocol packet containing credentials of said user after authenticating said user by an enterprise gateway; and
decrypting said user data by said at least one self-encrypting device, after receiving said protocol packet.

2. The method as in claim 1, wherein said storage tier comprises at least one tier, further said at least one tier comprises said at least one self-encrypting device.

3. The method as in claim 1, wherein said protocol packet is sent by an enterprise gateway and said protocol packet is received by storage tiering software in said storage tier.

4. The method as in claim 1, wherein said self-encrypting device comprises at least one of: solid state device, hard disk, any other device capable of performing automated encryption and decryption of said user data.

5. The method as in claim 1, wherein said protocol packet comprises at least one of: user identification details, information of said SEDs that are mapped to said user account and location to encrypt and decrypt.

6. A system for automated encryption and decryption of user data across an enterprise, wherein said system comprises an enterprise gateway, at least one self-encrypting device in a storage tier, a storage tiering software, wherein said system is configured to:
create a storage tier with at least one self-encrypting device to store said user data;
send a protocol packet containing credentials of said user after authenticating said user by said enterprise gateway; and
decrypt said user data by said at least one self-encrypting device, after receiving said protocol packet by said storage tiering software in said storage tier.

7. The system as in claim 6, wherein said enterprise gateway is configured to authenticate said user when said user logs on to said enterprise account with said credentials.

8. The system as in claim 6, wherein said storage tiering software is configured to identify said at least one self-encrypting device that is associated with said user data within said storage tier using said protocol packet.

9. The system as in claim 6, wherein said self-encrypting device is configured to decrypt said user data and stores said user data in a volatile memory and erase said user data in said volatile memory when said user logs out of said enterprise account.

10. The system as in claim 9, wherein said self-encrypting device is configured encrypt said user data when said user logs out from said enterprise account.

11. A self-encrypting device for automated encryption and decryption of user data across an enterprise, wherein said self-encrypting device comprises
an integrated circuit further comprising at least one processor;
at least one memory having a computer program code within said circuit;
said at least one memory and said computer program code configured to, with said at least one processor cause said self-encrypting device to:
decrypt said user data stored in data blocks of said self-encrypting device;
store said decrypted user data in a volatile memory;
erase said decrypted user data; and
encrypt said user data stored in said data blocks.

12. The self-encrypting device as in claim 11, wherein said self-encrypting device is configured to decrypt said user data after receiving protocol packet from at least one of: storage tiering software, an enterprise gateway.

13. The self-encrypting device as in claim 11, wherein self-encrypting device is configured to erase said decrypted user data when said user logs out of said enterprise account.

14. The self-encrypting device as in claim 11, wherein said self-encrypting device is configured to encrypt said user data in said data blocks, when said user updates said data, wherein said update comprises at least one of: adding, deleting, modifying.
